(19) United States
(12) Patent Application Publication
(10) Pub. No.: US 2011/0259914 A1
(43) Pub. Date: Oct. 27, 2011

(54) DUAL-STRUCTURE TUBE VESSEL AND METHOD OF PRODUCING THE SAME

(76) Inventors: Kang Joon LEE, Seoul (KR); Ho Kyung Park, Gyeonggi-do (KR)

(21) Appl. No.: 13/092,744

(22) Filed: Apr. 22, 2011

(30) Foreign Application Priority Data
Apr. 26, 2010 (KR) 10-2010-0038480

(51) Int. Cl. B65D 35/22; B32B 38/00

(52) U.S. Cl. 222/94; 156/251

(57) ABSTRACT

A dual-structure tube vessel and a method of producing the tube vessel are disclosed. The dual-structure tube vessel includes a cylindrical vessel body and a neck integrated with the vessel body into a single structure, and further includes: a body partitioning sheet provided in the vessel body and partitioning the interior of the vessel body into two sections; and a neck partitioning sheet provided in the neck and partitioning the interior of the neck into two sections. The vessel body and the body partitioning sheet may be fabricated using three sheets of material or one sheet of material. Further, the body partitioning sheet has a width equal to an inner circumference of a larger one of the two sections of the vessel body. Further, each of the vessel body and the body partitioning sheet is made of a threefold laminated sheet with a polyethylene/aluminum/polyethylene layered structure.

### CROSS-REFERENCE TO RELATED APPLICATIONS

The present application claims priority of Korean patent application number 10-2010-0038480 filed on Apr. 26, 2010, which is incorporated herein by reference in its entirety.

### BACKGROUND OF THE INVENTION

1. Field of the Invention

The present invention relates, in general, to a dual-structure tube vessel and a method of producing the dual-structure tube vessel and, more particularly, to a dual-structure tube vessel and a method of producing the dual-structure tube vessel, in which a partitioning sheet is provided in a single tube and partitions the interior and the mouth of the tube into sections, and creamy contents are contained in the respective sections and are discharged from the sections through the partitioned mouth at the same time, thereby maintaining a constant ratio of discharged amounts of contents.

2. Description of the Related Art

Generally, the hair dye that is on the market these days, is permanent hair dye consisting of an oxidizing agent and a hair dyeing agent consisting of dye and ammonia. To dye hair using hair dye, a user prepares hair dye by mixing a hair dyeing agent and an oxidizing agent, which are sold in a state in which they are contained in respective vessels. In the hair dyeing agent, ammonia expands the hair and opens the cuticle, thus allowing dye to pass into the cortex, while the oxidizing agent functions to capture the dye in the cortex.

In other words, hair dye oxidizes the melanin of hair, thus lightening the natural color of the hair, and assimilates chemical dye to the locations of pigments inside the hair and causes the dye to sit in the locations of pigments, thus dyeing the hair.

Typically, the hair dyeing agent and the oxidizing agent are kept in a state in which they are contained in respective vessels because when the hair dyeing agent and the oxidizing agent are contained in a single vessel, the hair dyeing agent and the oxidizing agent chemically react with each other and they become ineffective.

To dye hair, the hair dyeing agent and the oxidizing agent are mixed in a ratio of about 1:1 or 1.5:1. When the amount of hair dyeing agent in the mixture exceeds an appropriate amount, the amount of oxygen generated from hair dye excessively reduces, thus failing to realize the desired oxidation effect and weakening light reflection of the hair or causing dim color to appear in the hair, thereby making the color of dyed hair darker than a desired color. In contrast, when the amount of the oxidizing agent in the mixture exceeds an appropriate amount, the amount of oxygen generated from hair dye excessively increases, thus excessively oxidizing the hair dyeing agent, thereby failing to realize the desired color and easily decolorizing the hair, and making the color of dyed hair lighter than a desired color.

However, because the hair dyeing agent and the oxidizing agent of the hair dye, which are on the market these days, are contained in respective vessels, it is difficult to maintain a constant mixing ratio of the hair dyeing agent and the oxidizing agent.

Therefore, the color of dyed hair may be uneven, but there may be delicate shades of color of the dyed hair according to a difference in the mixing ratio of the hair dyeing agent and the oxidizing agent.

It is thus necessary to provide a technique of containing both the hair dyeing agent and the oxidizing agent in a single vessel and of discharging the hair dyeing agent and the oxidizing agent at the same time by compressing the vessel.

In an effort to achieve the above-mentioned requirement, a dual-structure tube vessel in which two inner tubes are inserted in one outer tube was proposed in Korean Utility Model Registration No. 20-0304903.

As shown in FIGS. 1 and 2, the dual-structure tube vessel according to the device comprises two inner tubes 50 and one outer tube 60. Each of the two inner tubes 50 includes a neck 52 having both a discharge hole 53 in an upper end and threads formed around an outer semi-circumferential surface. The inner tube 50 further includes a tube body 51 which has an adhering surface 55 extending downward from an outer surface of the neck 52 having no threads 54 and contains a creamy content 71, 72 therein. The outer tube 60 receives therein the two inner tubes 50 adhered to each other on the adhering surfaces 55, with a bonding agent 73 being applied to the inner surface of the outer tube 60 so as to increase the integrating strength between the inner and outer tubes 50 and 60. The outer tube 60 applied with the bonding agent 73 thermally shrinks, thus being integrated with the inner tubes 50. The dual-structure tube vessel of the device further includes a cap 65 which is tightened to the neck 52 having complete threads by uniting the two inner tubes 50 into a single body.

The conventional dual-structure tube vessel can discharge the two different contents at the same time so that the two contents can be mixed with each other at a constant ratio.

In other words, in the conventional dual-structure tube vessel, the two inner tubes 50 are integrated with the single outer tube 60, so that, when the outer tube 60 is compressed under constant pressure, the contents 71 and 72 contained in the inner tubes 50 can be discharged at a constant ratio through the discharge holes 53 formed in the necks 52 of the inner tubes 50.

Therefore, when it is necessary to use different creamy contents 71 and 72 by mixing them with each other like hair dye, a user can use the contents contained in the inner tubes 50 while easily mixing the contents at a constant ratio by simply compressing the outer tube 60.

However, the conventional dual-structure tube vessel is problematic in that because the two inner tubes are inserted into and integrated with the single outer tube into a single structure, the dual-structure tube vessel must be produced through a complicated process and consumes an excessive amount of material, thus increasing the production cost.

Further, the conventional dual-structure tube vessel is problematic in that because the two inner tubes are inserted into and integrated with the single outer tube into a single structure, the tube vessel has a substantial thickness due to thickness of the integrated inner and outer tubes, so that it is necessary to exert high pressure on the tube vessel when compressing the tube vessel and discharging the contents from the vessel.

Further, the conventional dual-structure tube vessel uses different materials as materials of the inner and outer tubes, so that it is difficult to manage the materials.

Further, when the conventional dual-structure tube vessel has been repeatedly used for a lengthy period, the bonding agent used for integrating the inner tubes with the outer tube becomes aged, so that the inner tubes may be easily separated from the outer tube.

Further, another problem of the conventional dual-structure tube vessel resides in that the bonding agent used for integrating the inner tubes with the outer tube pollutes the air during the vessel production process.

### SUMMARY OF THE INVENTION

Accordingly, the present invention has been made keeping in mind the above problems occurring in the related art, and the present invention is intended to propose a dual-structure tube vessel and a method of producing the tube vessel, in which both the mouth and interior of a tube are partitioned by a partitioning sheet into two sections and different contents are contained in the two sections, so that the contents can be easily discharged at the same time by compressing the tube vessel under a small pressure, and in which the tube vessel can be produced through a simple process using a small amount of material without using a bonding agent, thus reducing the production cost.

The present invention provides a dual-structure tube vessel including a cylindrical vessel body and a neck integrated with the vessel body into a single structure, the tube vessel further including: a body partitioning sheet provided in the vessel body and partitioning the interior of the vessel body into two sections; and a neck partitioning sheet provided in the neck and partitioning the interior of the neck into two sections.

Further, the vessel body and the body partitioning sheet of the present invention may be fabricated using three sheets of material.

Further, the vessel body and the body partitioning sheet of the present invention may be fabricated using one sheet of material.

Further, in the present invention, the width of the body partitioning sheet may be equal to the inner circumference of a larger one of the two sections of the vessel body.

Further, in the present invention, the two sections of the vessel body partitioned by the body partitioning sheet may be partitioned in a predetermined ratio, and the two sections of the neck partitioned by the neck partitioning sheet may be partitioned in the same ratio as that of the two sections of the vessel body.

Further, in the present invention, the vessel body and the body partitioning sheet may be made of a three-fold laminated sheet with a polyethylene/aluminum/polyethylene layered structure.

Further, in the present invention, the one sheet of material used as the material of the tube vessel may be cut so that the cut surface of the sheet is inclined relative to the cross-section of the sheet, and the edges having respective inclined cut surfaces of the sheet may be welded to the body of the sheet in such a way that the inclined cut surfaces are directed outside the vessel body.

Further, in the present invention, the body partitioning sheet may have an S-shaped appearance or a waved appearance.

Further, in an embodiment, the present invention provides a method of producing a dual-structure tube vessel, including: a cutting step of cutting a raw sheet into cut sheets having a predetermined width for producing at least one of a vessel body and a body partitioning sheet; a body partitioning sheet forming step of shaping a cut sheet produced at the cutting step, thus producing a body partitioning sheet having an S-shaped appearance; a welding step of welding opposite cut edges of the sheet after the body partitioning sheet forming step, thus forming a cylindrical vessel body; a lower mold inserting step of inserting a lower mold from the lower ends of the vessel body and the body partitioning sheet produced at the welding step; an injection molding step of injection-molding a neck and a neck partitioning sheet using a synthetic resin in a state in which an upper mold is placed on the vessel body after the lower mold inserting step, so that the neck, the neck partitioning sheet, the vessel body and the body partitioning sheet can be integrated with each other into a single body; a molded tube removing step of removing a molded tube from the mold after the injection molding step; and a sealing step of sealing the lower end of the vessel body through heating and compressing after the molded tube removing step, thus integrating the lower end of the vessel body with the lower end of the body partitioning sheet.

Further, in another embodiment, the present invention provides a method of producing a dual-structure tube vessel including: a body partitioning sheet forming step of shaping a middle part of a sheet into an S-shaped appearance, thus forming a body partitioning sheet; a welding step of welding opposite edges of the sheet after the body partitioning sheet forming step, thus forming a cylindrical vessel body; a length cutting step of transversely cutting the vessel body after the welding step, thus giving a desired length to the vessel body; a lower mold inserting step of inserting a lower mold from the lower ends of the vessel body and the body partitioning sheet produced at the length cutting step; an injection molding step of injection-molding a neck and a neck partitioning sheet using a synthetic resin in a state in which an upper mold is placed on the vessel body after the lower mold inserting step, so that the neck, the neck partitioning sheet, the vessel body and the body partitioning sheet can be integrated with each other into a single body; a molded tube removing step of removing a molded tube from the mold after the injection molding step; and a sealing step of sealing the lower end of the vessel body through heating and compressing after the molded tube removing step, thus integrating the lower end of the vessel body with the lower end of the body partitioning sheet.

Further, in the present invention, the sealing step may be performed after different creamy contents have been injected into the respective sections of the vessel body.

The dual-structure tube vessel of the present invention is advantageous in that the interior of a single tube is partitioned into two sections so that two different contents can be contained in the single tube vessel without being mixed with each other.

Further, the dual-structure tube vessel of the present invention is advantageous in that the partitioning sheet is integrally formed in the single tube so that, even when the tube is compressed with a small pressure, the contents contained in the tube can be easily discharged from the tube.

Further, the dual-structure tube vessel of the present invention is advantageous in that it does not use a bonding agent so that the tube vessel can avoid environmental pollution caused by the bonding agent and the materials of the tube vessel may not be separated from each other.

Further, the dual-structure tube vessel of the present invention is advantageous in that the vessel body and the body partitioning sheet may be fabricated using one sheet of material so that the tube vessel can be produced through a simple process using a small amount of material.

Further, the dual-structure tube vessel of the present invention is advantageous in that both the vessel body and the body partitioning sheet is made of a three-fold laminated sheet with a polyethylene/aluminum/polyethylene layered structure, so that a content sensitive of a specified material can be contained in the sections, thus increasing the range of materials to be injected into the sections.

Further, the dual-structure tube vessel of the present invention is advantageous in that the width of the body partitioning sheet is equal to the inner circumference of a larger one of the two sections of the vessel body, so that the tube can be completely compressed.

Further, the dual-structure tube vessel of the present invention is advantageous in that the two sections of the vessel body and the two sections of the neck are partitioned in a predetermined ratio, so that the ratio of discharged amounts of the contents can be maintained at a constant ratio.

Further, the dual-structure tube vessel of the present invention is advantageous in that the ratio of discharged amounts of contents can be variously controlled according to the location of the body partitioning sheet, so that a user can dye hair deeply or thinly as desired.

Further, the method of producing the dual-structure tube vessel according to the present invention is advantageous in that, when the neck and the neck partitioning sheet are injection-molded, the neck, the neck partitioning sheet, the vessel body and the body partitioning sheet can be integrated with each other, so that the method can produce the dual-structure tube vessel through a simple process and can realize a high integration strength of the neck, the neck partitioning sheet, the vessel body and the body partitioning sheet.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exploded perspective view illustrating a conventional dual-structure tube vessel;

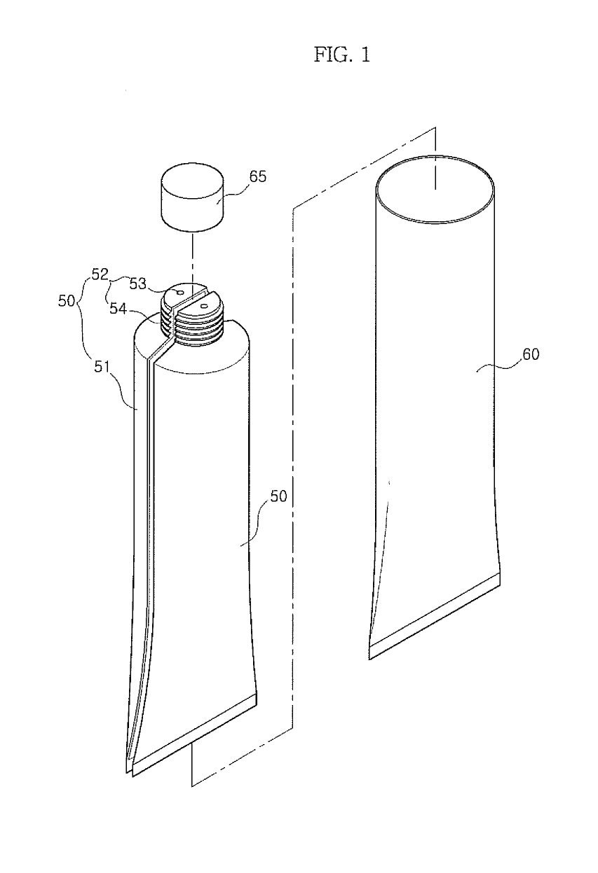

FIG. 2 is a side sectional view illustrating the conventional dual-structure tube vessel;

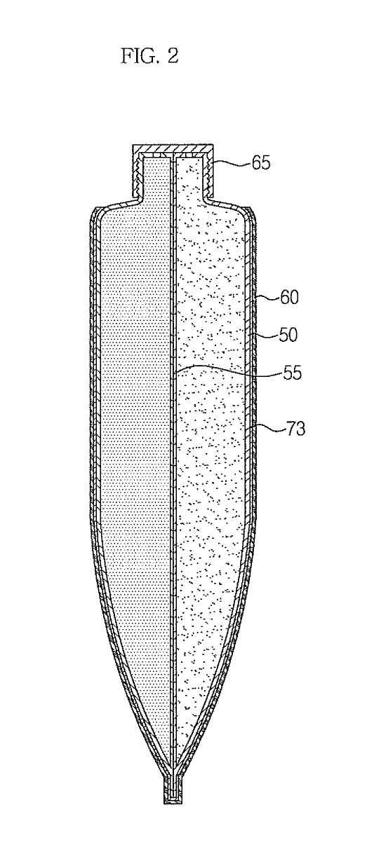

FIG. 3 is an exploded perspective view illustrating a dual-structure tube vessel according to the present invention;

FIG. 4 is a side sectional view illustrating the dual-structure tube vessel according to the present invention;

FIG. 5 is a perspective view illustrating a vessel body and a body partitioning sheet fabricated using three sheets of material according to the present invention;

FIG. 6 is a perspective view illustrating a vessel body and a body partitioning sheet fabricated using one sheet of material according to the present invention;

FIG. 7 is a flowchart illustrating a method of producing a dual-structure tube vessel according to the present invention;

FIG. 8 is a view illustrating the process of producing a dual-structure tube vessel according to the present invention; and

FIGS. 9(a) and 9(b) are a plan view and a bottom view of the vessel body having both a neck and a partitioning sheet according to the present invention.

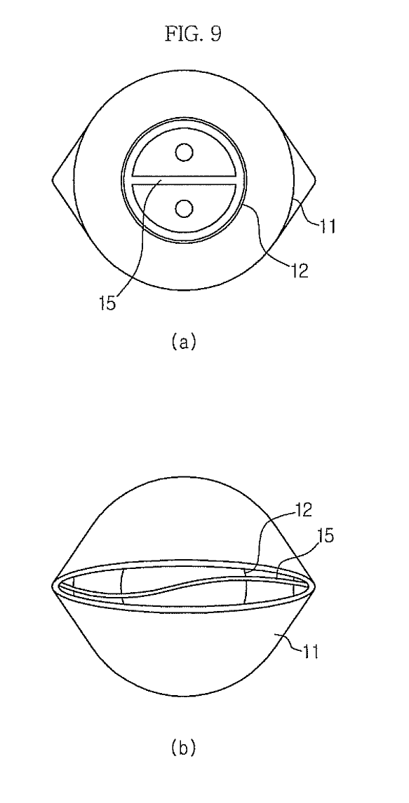

### DETAILED DESCRIPTION OF THE INVENTION

Hair dye, which is on the market and is used for dyeing hair by many people these days, is prepared by mixing a hair dyeing agent with an oxidizing agent. Typically, the hair dyeing agent and the oxidizing agent are contained in respective vessels made of different materials.

A user who wants to dye hair prepares hair dye by mixing a hair dyeing agent and an oxidizing agent at a predetermined ratio. To dye hair, the user takes appropriate amounts of hair dyeing agent and oxidizing agent from respective tube vessels into a mixing bowl and evenly mixes the hair dyeing agent with the oxidizing agent into a mixture, and combs the hair with a brush smeared with the mixture. Thus, the mixture dyes the hair due to a reaction of the hair dyeing agent with the oxidizing agent.

The hair dyeing agent intrinsically soaks and passes through polyethylene, so that when the hair dyeing agent is contained in a polyethylene vessel, the hair dyeing agent may leak out of the vessel. Thus, to prevent the hair dyeing agent from leaking out of a vessel, the hair dyeing agent has been typically contained in a vessel made of a metal film, which is an aluminum vessel.

Further, when the oxidizing agent comes into contact with metal, gas is generated therefrom due to a chemical reaction between the oxidizing agent and the metal. However, the oxidizing agent cannot soak through a polyethylene film, so that the oxidizing agent has been typically contained in a polyethylene vessel.

Therefore, the hair dyeing agent has been typically contained in a tube vessel made of a three-fold laminated film consisting of polyethylene/aluminum/polyethylene layers, while the oxidizing agent has been typically contained in a tube vessel made of a polyethylene film.

Hereinbelow, a dual-structure tube vessel and a method of producing the tube vessel according to the present invention will be described with reference to the accompanying drawings.

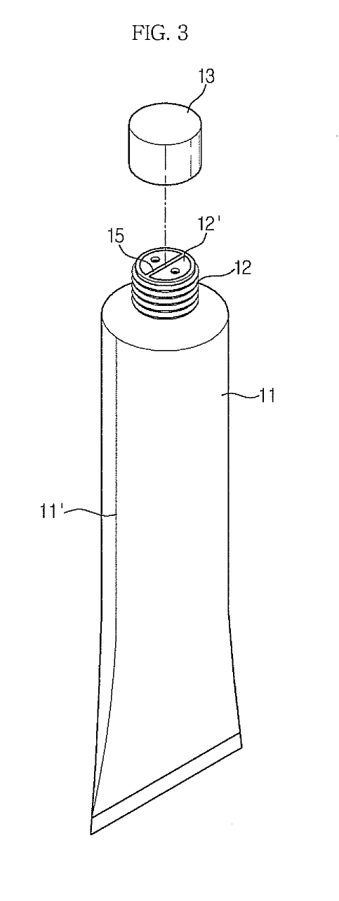

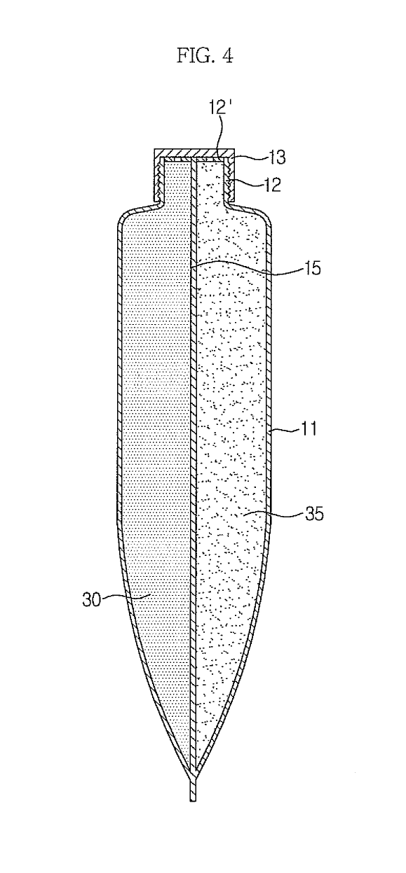

FIG. 3 is an exploded perspective view illustrating the dual-structure tube vessel according to the present invention, and FIG. 4 is a side sectional view of the dual-structure tube vessel according to the present invention. As shown in the drawings, the dual-structure tube vessel according to the present invention includes a vessel body 11, a body partitioning sheet 16, a neck 12 and a neck partitioning sheet 15.

The vessel body 11 has a cylindrical tube structure, while the neck 12 having a cylindrical shape is integrated with the upper end of the vessel body 11 into a single body through injection molding. The body partitioning sheet 16 is provided in the vessel body 11 and partitions the interior of the vessel body 11 into two sections. The neck partitioning sheet 15 is provided in the neck 12 and partitions the interior of the neck 12 into two sections.

The neck 12 may be provided with threads, a snap lock groove or a snap lock protrusion around the outer circumferential surface thereof. In the neck 12, respective mouths 12′ of the two sections of the partitioned neck may be open or closed. Respective discharge holes are provided in the mouths 12′ for discharging contents, which are creamy contents contained in the two sections of the partitioned vessel body 11 and the partitioned neck 12.

The open mouths 12′ or the discharge holes of the neck 12 may be covered with a sealing film made of aluminum, etc.

Further, a cap 13 may be removably tightened to the neck 12. The cap 13 may be provided with threads, a snap lock protrusion or a snap lock groove around the inner circumferential surface thereof so as to correspond to the structure of the outer circumferential surface of the neck 12.

The two sections, which are defined by partitioning the vessel body 11 and the neck 12 using the partitioning sheets 15 and 16, may contain different contents 30 and 35 therein.

Here, the neck partitioning sheet 15 is integrated with the neck 12 into a single body through injection molding. Further, the opposite edges of the neck partitioning sheet 15 are integrated with the inner surface of the sidewall of the vessel body 11, thus completely partitioning the interior of the vessel body 11 into two sections.

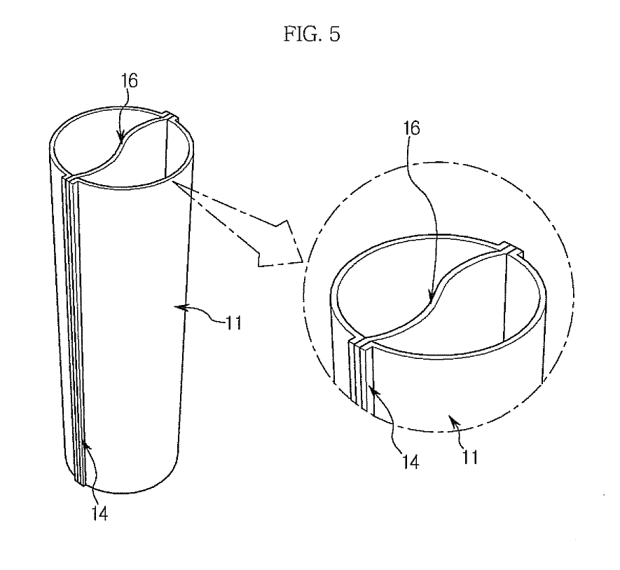

As shown in FIG. 5, which is a perspective view illustrating the vessel body and the body partitioning sheet fabricated using three sheets of material according to an embodiment of the present invention, the vessel body 11 and the body partitioning sheet 16 are fabricated using three pieces of threefold laminated sheet with a polyethylene/aluminum/polyethylene layered structure. The vessel body 11 and the body partitioning sheet 16 will be described in detail hereinbelow.

To produce the vessel body 11 and the body partitioning sheet 16, a raw sheet 10 of the tube vessel is cut into three sheets having the same width in consideration of a desired size of the vessel body 11. Thereafter, the three sheets 10′ are placed one on top of another and opposite side edges of the three sheets 10′ are heated to become pasty using a high-frequency heating machine and are compressed using a press, thus forming welded edges 14.

When the three welded sheets 10′ are shaped into a cylindrical tube, two outside sheets 10′ form the cylindrical vessel body 11 and one inside sheet 10′ forms the body partitioning sheet 16.

Here, the width of the body partitioning sheet 16 is equal to ½ of the inner circumference of the vessel body 11, so that the width of the body partitioning sheet 16 becomes equal to the inner circumference of a larger one of the two sections of the vessel body 11. Therefore, when the body partitioning sheet 16 is shaped into an S-shaped appearance so that the body partitioning sheet 16 does not lean to any one of the two sections in the vessel body 11, the interior of the vessel body 11 can be evenly partitioned into two sections having the same volume by the body partitioning sheet 16.

Further, to evenly partition the interior of the neck 12 into two sections using the neck partitioning sheet 15 so that the two sections of the neck 15 correspond to the two sections of the vessel body 11, the neck 12 and the neck partitioning sheet 15 are formed using synthetic resin 17 through injection molding such that the neck 12, the neck partitioning sheet 15, the vessel body 11 and the body partitioning sheet 16 can be integrated with each other into a single body.

Thereafter, the lower end of the vessel body 11 is subjected to compression welding so that the lower end of the vessel body 11 can be integrated with the lower end of the body partitioning sheet 16.

Here, the two outside sheets 10′ have the same length, so that the two sections of the vessel body partitioned by the body partitioning sheet 16 have the same volume. Therefore, the two partitioned sections of the vessel body can contain the same amount of contents therein and the contents contained in respective sections can be discharged through respective discharge holes at a ratio of 50:50.

When a hair dyeing agent is contained in one of the two sections of the vessel body 11 and an oxidizing agent is contained in the other section, the hair dyeing agent and the oxidizing agent can be discharged at a ratio of 50:50, so that a user who wants to dye hair can easily mix the hair dyeing agent and the oxidizing agent with each other at a ratio of 1:1. Therefore, the user may not pay careful attention to the mixing ratio of the hair dyeing agent and the oxidizing agent.

Further, in the embodiment in which the vessel body 11 and the body partitioning sheet 16 are fabricated using three sheets of material, the interior of the vessel body 11 may be partitioned by the body partitioning sheet 16 into two sections having different volumes as will be described hereinbelow.

To produce the vessel body 11 and the body partitioning sheet 16, a raw sheet 10 of the tube vessel is cut into three sheets in consideration of a desired size of the vessel body 11. Here, the raw sheet 10 is cut into three sheets so that two of the three sheets have the same width and one remaining sheet has a width smaller than that of the two large sheets. Thereafter, the two sheets 10′ having the same width are placed on top of another and the remaining sheet having the smaller width is placed on the two sheets 10′ and opposite side edges of the three sheets 10′ are heated to become pasty using a high-frequency heating machine and are compressed using a press, thus foaming welded edges 14.

When the three welded sheets 10′ are shaped into a cylindrical tube, both the sheet having the smaller width and the outside one of the two sheets 10′ having the same width form the cylindrical vessel body 11, while the inside one of the two sheets 10′ having the same width forms the body partitioning sheet 16.

Here, the width of the body partitioning sheet 16 becomes equal to the inner circumference of a larger one of the two sections of the vessel body 11. Therefore, when the body partitioning sheet 16 is shaped into an S-shaped appearance so that the body partitioning sheet 16 does not lean onto any one of the two sections in the vessel body 11, the interior of the vessel body 11 can be stably partitioned into two sections having different volumes by the body partitioning sheet 16.

Further, to partition the interior of the neck 12 into two sections using the neck partitioning sheet 15 so that the ratio of the two sections of the neck 15 corresponds to that of the two sections of the vessel body 11, the neck 12 and the neck partitioning sheet 15 are formed using synthetic resin 17 through injection molding so that the neck 12, the neck partitioning sheet 15, the vessel body 11 and the body partitioning sheet 16 can be integrated with each other into a single body.

For example, the raw sheet of the tube vessel may be cut into three sheets so that two of the three sheets have the same width and one remaining sheet has a width of ⅓ of the width of the two large sheets. Thereafter, the two sheets having the same width are placed one on top of another and the remaining sheet having the smaller width is placed on the two sheets and opposite side edges of the three sheets are united using a high-frequency heating machine and a press as described above, thus forming welded edges.

When the three welded sheets are shaped into a cylindrical tube, the body partitioning sheet partitions the interior of the vessel body into two sections having different volumes of a ratio of 1:2.

When the three sheets are cut from the raw sheet so that they have surplus widths in consideration of the welded edges and the three sheets are shaped into a cylindrical tube, the body partitioning sheet can partition the interior of the vessel body into two sections having different volumes of a ratio of 1:2.

Thereafter, the lower end of the vessel body 11 is subjected to compression welding so that the lower end of the vessel body 11 can be integrated with the lower end of the body partitioning sheet 16.

Here, because the two sections of the vessel body are partitioned by the body partitioning sheet so that they have respective volumes of a ratio of 1:2, the two partitioned sections can contain 1:2 amounts of contents therein and the contents contained in respective sections can be discharged through respective discharge holes at a ratio of 1:2.

Therefore, the present invention can freely control the ratio of volumes of the two sections partitioned by the body partitioning sheet, thus freely controlling the ratio of discharged amounts of the contents from the two sections.

In other words, in the present invention, the volume ratio of the two sections of the vessel body partitioned by the body partitioning sheet can be variously controlled according to the location of the body partitioning sheet, such that the ratio of discharged amounts of contents contained in the two sections can be variously controlled. Therefore, a user can dye hair while easily controlling the hue of the dyed hair deeply or thinly as desired.

When the oxidizing agent is contained in a tube vessel made of a laminated sheet designed for containing the hair dyeing agent, gas is generated from the vessel. This is caused by the process of producing the tube vessel, which remains the cut surface of the laminated sheet in a state in which the cut surface is completely exposed to the interior of the tube vessel and the exposed cut surface of the laminated sheet includes aluminum placed in the middle layer of the threefold laminated sheet.

In the related art, there is no method of producing a tube vessel, which is fabricated using the same material and can contain both the hair dyeing agent and the oxidizing agent therein. In an effort to solve the problem, the present invention provides a technique of producing the vessel body 11 and the body partitioning sheet 16 using one sheet of material.

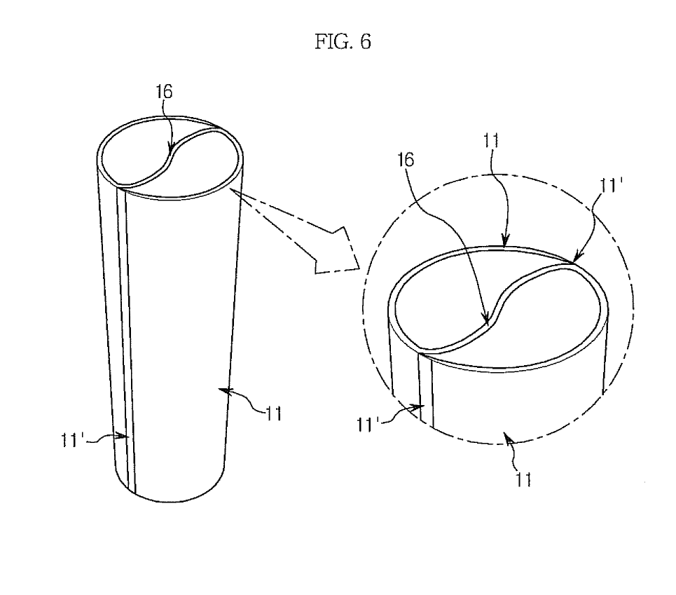

As shown in FIG. 6, which is a perspective view illustrating the vessel body and the body partitioning sheet fabricated using one sheet of material according to the present invention, the vessel body 11 and the body partitioning sheet 16 can be produced using one piece of three-fold laminated sheet with a polyethylene/aluminum/polyethylene layered structure. The vessel body 11 and the body partitioning sheet 16 will be described in detail hereinbelow.

To produce the vessel body 11 and the body partitioning sheet 16, a sheet having a constant width is cut from a raw sheet 10 of the tube vessel in consideration of a desired size of the vessel body 11. Thereafter, a first edge of the cut sheet 10′ is placed along a line on the sheet 10′ spaced apart from a second edge of the sheet 10′ by ⅓ of the width of the sheet 10′ and the inner and outer surfaces of the contact parts of the sheet 10′ are heated to become pasty using a high-frequency heating machine and are compressed using a press, thus forming a welded line 11′.

Thereafter, the second edge of the cut sheet 10′ is placed along another line on the sheet 10′ spaced apart from the first edge of the sheet 10′ by ⅓ of the width and the inner and outer surfaces of the contact parts of the sheet 10′ are heated to become pasty using the high-frequency heating machine and are compressed using the press, thus forming another welded line 11′.

When the welded sheet 10′ is shaped into a cylindrical tube, the first edge of the sheet 10′ is located at a position of ½ of the circumference of the vessel body 11, while the second edge of the sheet 10′ is located at a diametrically opposite position of ½ of the circumference of the vessel body 11. In other words, the two welded lines 11′ are located at diametrically opposite positions of the vessel body 11, with a body partitioning sheet 16 being formed inside the vessel body 11.

Thereafter, the lower end of the vessel body 11 is subjected to compression welding so that the lower end of the vessel body 11 can be integrated with the lower end of the body partitioning sheet 16.

In this embodiment in which the vessel body 11 and the body partitioning sheet 16 are fabricated using one sheet, the two sections of the vessel body 11 partitioned by the body partitioning sheet 16 have the same volume in the same manner as that described for the embodiment in which the vessel body and the body partitioning sheet 16 are fabricated using three sheets such that the two sections of the vessel body 11 partitioned by the body partitioning sheet 16 have the same volume. The operational effects of this embodiment remain the same as those of the embodiment in which the vessel body 12 and the body partitioning sheet 16 are fabricated using three sheets and further explanation is not deemed necessary.

Further, in the embodiment in which the vessel body 11 and the body partitioning sheet 16 are fabricated using one sheet of material, the interior of the vessel body 11 may be partitioned by the body partitioning sheet 16 into two sections having different volumes as will be described hereinbelow.

To produce the vessel body 11 and the body partitioning sheet 16, a sheet having a constant width is cut from a raw sheet 10 of the tube vessel in consideration of a desired size of the vessel body 11. Thereafter, a first edge of the cut sheet 10′ is placed along a line on the sheet 10′ spaced apart from a second edge of the sheet 10′ by ⅖ of the width of the sheet 10′ and the inner and outer surfaces of the contact parts of the sheet 10′ are heated to become pasty using a high-frequency heating machine and are compressed using a press, thus forming a welded line 11′.

Thereafter, the second edge of the cut sheet 10′ is placed along another line on the sheet 10′ spaced apart from the first edge of the sheet 10′ by ⅖ of the width and the inner and outer surfaces of the contact parts of the sheet 10′ are heated to become pasty using the high-frequency heating machine and are compressed using the press, thus forming another welded line 11′.

When the welded sheet 10′ is shaped into a cylindrical tube, the first edge of the sheet 10′ is located at a position of ⅓ of the circumference of the vessel body 11, while the second edge of the sheet 10′ is located at a position of ⅔ of the circumference of the vessel body 11. In other words, the two welded lines 11′ are located at respective positions on the circumferential surface of the vessel body 11 while being angularly spaced apart from each other at an angle of 60 degrees based on the vessel body 11, with the body partitioning sheet 16 being formed inside the vessel body 11.

Thereafter, the lower end of the vessel body 11 is subjected to compression welding such that the lower end of the vessel body 11 can be integrated with the lower end of the body partitioning sheet 16.

In this embodiment in which the vessel body 11 and the body partitioning sheet 16 are fabricated using one sheet, the two sections of the vessel body 11 partitioned by the body partitioning sheet 16 have different volumes in the same manner as that described for the embodiment in which the vessel body and the body partitioning sheet 16 are fabricated using three sheets such that the two sections of the vessel body 12 partitioned by the body partitioning sheet 16 have different volumes. The operational effects of this embodiment remain the same as those of the embodiment in which the vessel body 12 and the body partitioning sheet 16 are fabricated using three sheets and further explanation is not deemed necessary.

The present invention having the above-mentioned construction is advantageous in that a user can discharge the hair dyeing agent and the oxidizing agent from respective sections of the tube vessel into a mixing bowl at a constant ratio, thus dyeing hair in a constant hue.

When the user dyes hair with hair dye while mixing the hair dyeing agent and the oxidizing agent with each other to produce the hair dye according to eye measure, the mixing ratio of the hair dyeing agent and the oxidizing agent may not be kept constant, so that the color tone of the dyed hair may be partially deep and thin. The present invention can solve the problem.

Further, in the present invention, the body partitioning sheet 16 is shaped into an S-shaped appearance and has a width equal to the inner circumference of a larger one of the two sections of the vessel body 11. The above-mentioned relationship between the body partitioning sheet 16 and the vessel body 11 results in the following advantages. When the contents are discharged from respective sections by compressing the vessel body 11, the body partitioning sheet 16 can come into close contact with the vessel body 11 because the width of the body partitioning sheet 16 is equal to the inner circumference of the larger one of the two sections of the vessel body 11. Thus, it is possible to effectively discharge the contents from the vessel body 11.

However, when the width of the body partitioning sheet 16 is shorter than the inner circumference of the larger one of the two sections of the vessel body 11, the user cannot completely compress the larger section of the vessel body 11 due to the shorter width of the body partitioning sheet 16 relative to the inner circumference of the larger section, such that the user cannot completely discharge the content from the larger section. Further, in the above state, the user cannot evenly compress the vessel body 11, such that the contents cannot be discharged from respective sections at a constant ratio.

Further, in the present invention, the shape of the body partitioning sheet 16 may be changed without being limited to the S-shaped appearance. For example, the body partitioning sheet 16 may have a waved shape and the change in the shape of the body partitioning sheet 16 can be easily executed by those skilled in the art without departing from the scope and spirit of the invention.

Both the vessel body 11 and the body partitioning sheet 16 are fabricated using a three-fold laminated sheet with a polyethylene/aluminum/polyethylene layered structure as described above.

Regardless of the number of laminated sheets constituting the vessel body 11 and the body partitioning sheet 16 which may be fabricated using one or three sheets according to the present invention, each laminated sheet has the polyethylene/aluminum/polyethylene layered structure, so that the inner surfaces of the two sections partitioned by the body partitioning sheet 16 are defined by polyethylene layers.

As described above, the hair dyeing agent can pass through polyethylene, but cannot pass through aluminum, such that the hair dyeing agent can be contained in any one of the two sections of the vessel body 11 partitioned by the body partitioning sheet 16 and the hair dyeing agent does not leak from the vessel body 11 due to the aluminum layer of the laminated sheet.

Further, when the oxidizing agent is brought into contact with metal, the oxidizing agent generates gas due to a chemical reaction with the metal. However, the oxidizing agent cannot pass polyethylene, so that the oxidizing agent can be contained in either one of the two sections of the vessel body 11 partitioned by the body partitioning sheet 16 and the oxidizing agent does not leak from the vessel body 11 due to the polyethylene layer of the laminated sheet.

Therefore, the dual-structure tube vessel of the present invention is advantageous in that it can contain various chemicals therein without being limited to the hair dyeing agent or to the oxidizing agent.

Further, in the dual-structure tube vessel of the present invention, the one sheet used as the material of the tube vessel is cut from a raw sheet so that the cut surface of the sheet is inclined relative to the cross-section of the sheet. The edges having respective inclined cut surfaces of the sheet are welded to the body of the sheet in such a way that the inclined cut surfaces are directed outside the vessel body 11.

The raw sheet 10 used as the material of the tube vessel is a laminated sheet with a polyethylene/aluminum/polyethylene layered structure, so that, when the raw sheet 10 is cut into pieces of sheets, aluminum is exposed outside at the cut surfaces of each cut sheet 10′.

When the vessel body 11 and the body partitioning sheet 16 are fabricated using one sheet 10′ having aluminum exposed at the cut surfaces, the exposed aluminum may be carelessly welded to the inner surface of one of the two sections partitioned by the body partitioning sheet 16.

In the above state, the section having the exposed aluminum can contain the hair dyeing agent therein. However, when the oxidizing agent is contained in the section having the exposed aluminum, gas is generated from a chemical reaction between the oxidizing agent and aluminum, so that the oxidizing agent may become ineffective.

In order to prevent the chemical reaction, a sheet used as the material of the tube vessel is cut from a raw sheet 10 so that the cut surface of the sheet is inclined relative to the cross-section of the sheet. Further, the dual-structure tube vessel is fabricated by welding the edges having respective inclined cut surfaces to the body of the sheet in such a way that the inclined cut surfaces are directed outside the vessel body 11. In the tube vessel, polyethylene of the body partitioning sheet 16 is welded to the polyethylene layer of the inner surface of the vessel body 11, so that aluminum is not exposed to the interior of any section. Therefore, it is possible to contain the hair dyeing agent and the oxidizing agent in the two sections without distinguishing the sections from each other for the two agents.

In the above description, the dual-structure tube vessel of the present invention contains the hair dyeing agent and the oxidizing agent in partitioned sections. However, the dual-structure tube vessel of the present invention may be used for containing two different creamy products which are typically used together.

For example, shampoo and rinse, lotion and nourishing cream, or painting colors may be contained in the dual-structure tube vessel of the present invention.

In the vessel body 11, the contents 30 and 35 contained in respective sections can be maintained in a state in which they have not been mixed together before they are discharged from the respective sections through the mouths 12′ of the neck 12.

The dual-structure tube vessel of the present invention can effectively contain two different creamy contents 30 and 35, which are typically used in a mixed state, but they are not sold in the mixed state because they become ineffective if they are kept in a mixed state prior to being used. Further, because the two different creamy contents 30 and 35 are contained in respective sections of the tube vessel in an isolated state, it is easy to carry the contents and it is not required to manually control the mixing ratio of the contents when using them.

The present invention may be adapted to a pouch type liquid container in addition to the tube vessel. In the above state, a partitioning sheet is provided in the container and partitions the interior of the container into two sections, so that two different liquid contents, which may become ineffective if they are kept in a mixed state prior to being used, can be effectively contained in respective sections of the container in an isolated state.

In this embodiment, the partitioning sheet may not be integrated with the bag body of the liquid container through injection molding, but the container may be produced through forming with a partitioning sheet being inserted between two sheets so that the interior of the container can be partitioned into sections by the partitioning sheet.

As described above, the dual-structure tube vessel according to the present invention has two sections partitioned in a single vessel body, such that two different contents can be contained in respective sections of the single vessel body in an isolated state. Further, the partitioning sheet is integrated with the vessel body at a location inside the vessel body, such that although the vessel body is compressed under small pressure, the contents may be easily and effectively discharged from the vessel body. Further, the dual-structure tube vessel of the present invention does not use a bonding agent, such that it does not pollute environment caused by the bonding agent and prevents the sheets from being separated from each other. Further, the vessel body and the body partitioning sheet are fabricated using one sheet of material, so that the tube vessel can be produced through a simple process using a small amount of material

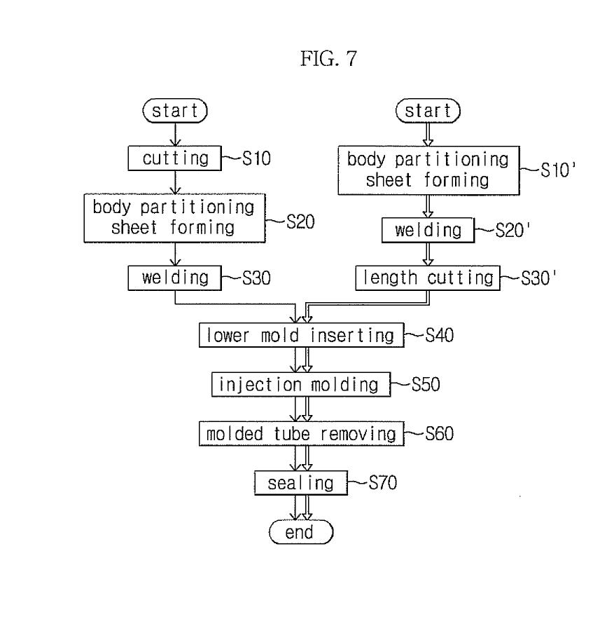

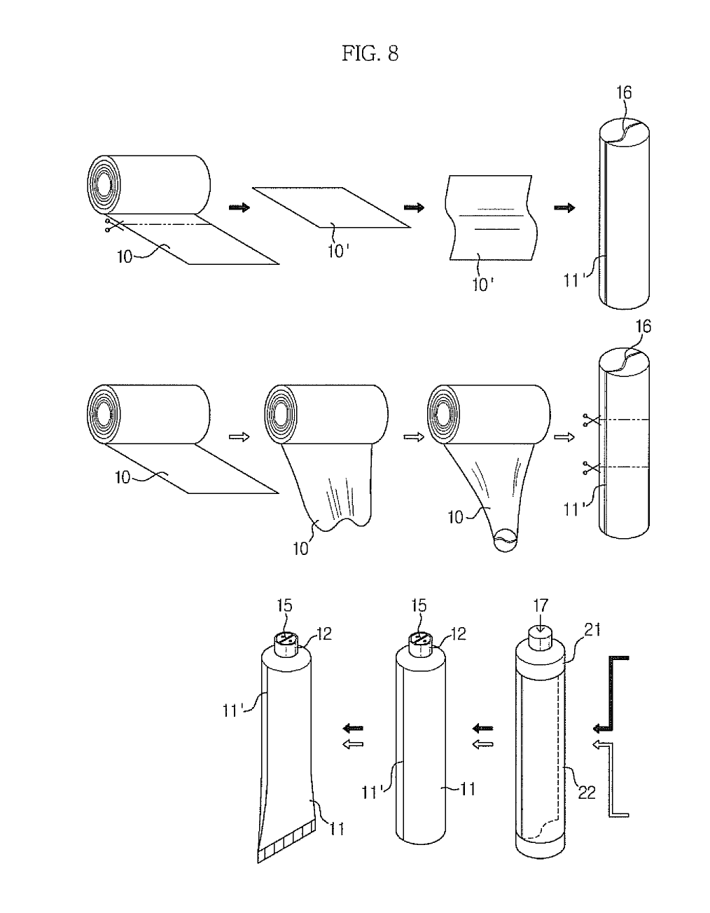

Hereinbelow, a method of producing the dual-structure tube vessel according to the present invention will be described: FIG. 7 is a flowchart illustrating the method of producing the dual-structure tube vessel according to the present invention. FIG. 8 is a view illustrating the process of producing the dual-structure tube vessel according to the present invention.

Each of FIG. 7 and FIG. 8 illustrates the successive steps of the procedure of the two methods of producing the dual-structure tube vessels respectively using one sheet and three sheets in one view.

The method of producing the dual-structure tube vessel according to the present invention includes: cutting step S10 of cutting a raw sheet 10 into cut sheets having a predetermined width for producing at least one of a vessel body 11 and a body partitioning sheet 16; body partitioning sheet forming step S20 of shaping a cut sheet 10′ produced at the cutting step S10, thus producing a body partitioning sheet 16 having an S-shaped appearance; welding step S30 of welding opposite cut edges of the sheet 10′ after the body partitioning sheet forming step S20, thus forming a cylindrical vessel body 11; lower mold inserting step S40 of inserting a lower mold 22 from the lower ends of the vessel body 11 and the body partitioning sheet 16 produced at the welding step S30; injection molding step S50 of injection-molding a neck 12 and a neck partitioning sheet 15 using a synthetic resin 17 in a state in which an upper mold 21 is placed on the vessel body 11 after the lower mold inserting step S40, so that the neck 12, the neck partitioning sheet 15, the vessel body 11 and the body partitioning sheet 16 can be integrated with each other into a single body; molded tube removing step S60 of removing a molded tube from the mold after the injection molding step S50; and sealing step S70 of sealing the lower end of the vessel body 11 through heating and compressing after the molded tube removing step S60, thus integrating the lower end of the vessel body 11 with the lower end of the body partitioning sheet 16.

In the above-mentioned process, the sealing step S70 is performed after injecting different creamy contents 30 and 35 into respective sections of the vessel body 11.

The method of producing the dual-structure tube vessel according to the present invention can easily produce a dual-structure tube vessel, which can contain two different contents required to be contained in respective sections in an isolated state, through a simple process.

To produce the dual-structure tube vessel according to the present invention, a rolled raw sheet 10 is cut into sheets 10′ having a predetermined width for producing a vessel body 11 and a body partitioning sheet 16 in consideration of the size of the vessel body 11. Thereafter, a cut sheet 10′ produced at the cutting step S10 is shaped into an S-shaped appearance, thus forming a body partitioning sheet 16. Opposite cut edges of the body partitioning sheet 16 are heated to become pasty using a high-frequency heating machine and are compressed using a press, thus forming a cylindrical vessel body 11.

Thereafter, the vessel body 11 is inserted into an injection molding machine, in which a lower mold 22 is inserted from the lower ends of the vessel body 11 and the body partitioning sheet 16 produced at the welding step S30 and an upper mold 21 is placed on the vessel body 11. In the injection molding machine, a neck 12 and a neck partitioning sheet 15 are injection-molded using a synthetic resin 17 such that the neck 12, the neck partitioning sheet 15, the vessel body 11 and the body partitioning sheet 16 can be integrated with each other into a single body.

Therefore, the interior of the vessel body 11 can be partitioned into two sections by the body partitioning sheet 16 and both the neck 12 and the neck partitioning sheet can be integrated with the upper end of the vessel body 11.

When the neck partitioning sheet 15 and the neck 12 are completely molded, the vessel body 11 is removed from the injection molding machine and different creamy contents 30 and 35 are injected into respective sections of the vessel body 11.

For example, when the dual-structure tube vessel is used as a container for hair dye, a hair dyeing agent is injected into one section of the vessel body 11, while an oxidizing agent is injected into the remaining section.

Here, in order to prevent the injected contents 30 and 35 from the vessel body 11 through the mouths 12′ of the neck 12, a cap 13 may be tightened to the neck 12. However, when the contents 30 and 35 are creamy contents having high viscosities, it is preferred that no cap 13 be tightened to the neck 12.

When a cap 13 is tightened to the neck 12 of the vessel body for containing highly viscous creamy contents 30 and 35, it may be difficult to inject the contents 30 and 35 into respective sections.

After the contents 30 and 35 are completely injected into respective sections of the vessel body 11, the lower end of the vessel body 11 is sealed through heating and compressing using a high-frequency heating machine and a press. Therefore, the vessel body 11 which has been already integrated with the body partitioning sheet 16 along the welded edges 14 is integrated with the lower end of the body partitioning sheet 16.

Therefore, when the lower end of the vessel body 11 is sealed after the contents 30 and 35 have been injected into respective sections of the vessel body 11, the lower end of the body partitioning sheet 16 can be prevented from being misaligned with the lower end of the vessel body 11.

Thereafter, a cap 13 is tightened to the neck 12 when necessary, thus finishing the process of producing a product.

In a second embodiment of the present invention, there is provided a method of producing a dual-structure tube vessel, which includes: body partitioning sheet forming step S10′ of shaping a middle part of a cut sheet 10′ into an S-shaped appearance, thus forming a body partitioning sheet 16; welding step S20′ of welding opposite edges of the sheet 10′ after the body partitioning sheet forming step, thus forming a cylindrical vessel body 11; length cutting step S30′ of transversely cutting the vessel body 1 after the welding step S20′, thus giving a desired length to the vessel body 11; lower mold inserting step S40 of inserting a lower mold 22 from the lower ends of the vessel body 11 and the body partitioning sheet 16 produced at the length cutting step S30′; injection molding step S50 of injection-molding a neck 12 and a neck partitioning sheet 15 using a synthetic resin 17 in a state in which an upper mold 21 is placed on the vessel body 11 after the lower mold inserting step S40, so that the neck 12, the neck partitioning sheet 15, the vessel body 11 and the body partitioning sheet 16 can be integrated with each other into a single body; molded tube removing step S60 of removing a molded tube from the mold after the injection molding step S50; and sealing step S70 of sealing the lower end of the vessel body 11 through heating and compressing after the molded tube removing step S60, thus integrating the lower end of the vessel body 11 with the lower end of the body partitioning sheet 16.

In this second embodiment, the sequence of the cutting step, the body partitioning sheet forming step and the welding step are changed from that of the first embodiment and the process of forming the body partitioning sheet 16 from the cut sheet 10′ is altered. However, the sequence and detailed processes of the remaining steps, which are the lower mold inserting step S40, the injection molding step S50, the molded tube removing step S60 and the sealing step S70, remain the same as those described for the first embodiment.

In the method according to this second embodiment, the axial middle part of the rolled raw sheet 10 is shaped into an S-shaped appearance from the end of the sheet and opposite edges of the sheet are heated to become pasty using a high-frequency heating machine and are compressed using a press, thus forming a cylindrical vessel body 11. Thereafter, to give a desired length to the vessel body 11, the vessel body 1 and the body partitioning sheet 16 are simultaneously transversely cut.

In this embodiment, the vessel body 1 and the body partitioning sheet 16 may be freely cut from the raw sheet at a desired position, so that it is easy to give desired lengths to the vessel body 1 and the body partitioning sheet 16.

Further, the lower mold inserting step S40, the injection molding step S50, the molded tube removing step S60 and the sealing step S70, which are successively performed after the length cutting step S30′, remain the same as those of the first embodiment and further explanation is omitted.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A dual-structure tube vessel comprising a cylindrical vessel body and a neck integrated with the vessel body into a single structure, the tube vessel further comprising:
a body partitioning sheet provided in the vessel body and partitioning an interior of the vessel body into two sections; and
a neck partitioning sheet provided in the neck and partitioning an interior of the neck into two sections.

2. The dual-structure tube vessel as set forth in claim 1, wherein the vessel body and the body partitioning sheet is fabricated using three sheets of material.

3. The dual-structure tube vessel as set forth in claim 1, wherein the vessel body and the body partitioning sheet are fabricated using one sheet of material.

4. The dual-structure tube vessel as set forth in claim 2, wherein the body partitioning sheet has a width equal to an inner circumference of a larger one of the two sections of the vessel body.

5. The dual-structure tube vessel as set forth in claim 2, wherein
the two sections of the vessel body partitioned by the body partitioning sheet are partitioned at a predetermined ratio, and
the two sections of the neck partitioned by the neck partitioning sheet are partitioned at the same ratio as that of the two sections of the vessel body.

6. The dual-structure tube vessel as set forth in claim 2, wherein each of the vessel body and the body partitioning sheet is made of a three-fold laminated sheet with a polyethylene/aluminum/polyethylene layered structure.

7. The dual-structure tube vessel as set forth in claim 3, wherein the one sheet of material is cut so that a cut surface of the sheet is inclined relative to a cross-section of the sheet, and edges having respective inclined cut surfaces of the sheet are welded to a body of the sheet in such a way that the inclined cut surfaces are directed outside the vessel body.

8. The dual-structure tube vessel as set forth in claim 3, wherein the body partitioning sheet has an S-shaped appearance or a waved appearance.

9. A method of producing a dual-structure tube vessel, comprising:
a cutting step of cutting a raw sheet into cut sheets having a predetermined width for producing at least one of a vessel body and a body partitioning sheet;
a body partitioning sheet forming step of shaping a cut sheet produced at the cutting step, thus producing a body partitioning sheet having an S-shaped appearance;
a welding step of welding opposite cut edges of the sheet after the body partitioning sheet forming step, thus forming a cylindrical vessel body;
a lower mold inserting step of inserting a lower mold from lower ends of the vessel body and the body partitioning sheet produced at the welding step;
an injection molding step of injection-molding a neck and a neck partitioning sheet using a synthetic resin in a state in which an upper mold is placed on the vessel body after the lower mold inserting step, so that the neck, the neck partitioning sheet, the vessel body and the body partitioning sheet can be integrated with each other into a single body;
a molded tube removing step of removing a molded tube from the mold after the injection molding step; and
a sealing step of sealing a lower end of the vessel body through heating and compressing after the molded tube removing step, thus integrating the lower end of the vessel body with a lower end of the body partitioning sheet.

10. A method of producing a dual-structure tube vessel, comprising:
a body partitioning sheet forming step of shaping a middle part of a sheet into an S-shaped appearance, thus forming a body partitioning sheet;
a welding step of welding opposite edges of the sheet after the body partitioning sheet forming step, thus forming a cylindrical vessel body;
a length cutting step of transversely cutting the vessel body after the welding step, thus giving a desired length to the vessel body;
a lower mold inserting step of inserting a lower mold from lower ends of the vessel body and the body partitioning sheet produced at the length cutting step;
an injection molding step of injection-molding a neck and a neck partitioning sheet using a synthetic resin in a state in which an upper mold is placed on the vessel body after the lower mold inserting step, so that the neck, the neck partitioning sheet, the vessel body and the body partitioning sheet can be integrated with each other into a single body;
a molded tube removing step of removing a molded tube from the mold after the injection molding step; and
a sealing step of sealing a lower end of the vessel body through heating and compressing after the molded tube removing step, thus integrating the lower end of the vessel body with the lower end of the body partitioning sheet.

11. The method as set forth in 9, wherein the sealing step is performed after different creamy contents have been injected into the respective sections of the vessel body.
